(19) United States
(12) Patent Application Publication
(10) Pub. No.: US 2014/0353252 A1
(43) Pub. Date: Dec. 4, 2014

(54) Method of Supplying Engineered Waters for Drilling and Hydraulic Fracturing Operations for Wells and Recapturing Minerals and Other Components from Oil and Gas Production Waste Waters

(71) Applicants: Stephen Earl Hester, The Woodlands, TX (US); Leslie Douglas Merrill, Bountiful, UT (US); Christopher R. Lloyd, Noth Logan, UT (US)

(72) Inventors: Stephen Earl Hester, The Woodlands, TX (US); Leslie Douglas Merrill, Bountiful, UT (US); Christopher R. Lloyd, Noth Logan, UT (US)

(73) Assignee: 212 Resources, Houston, TX (US)

(21) Appl. No.: 14/348,421

(22) PCT Filed: Sep. 12, 2012
(86) PCT No.: PCT/US12/54706

§ 371 Date: Jun. 20, 2014

Related U.S. Application Data
(60) Provisional application No. 61/540,163, filed on Sep. 28, 2011.
(60) Provisional application No. 61/563,248, filed on Nov. 23, 2011.

(51) Int. Cl. E21B 43/40; C02F 1/44; C02F 1/72; C02F 1/52; C02F 9/00; C02F 1/32; C02F 1/04; C02F 1/00; C02F 3/04; C02F 3/12; C02F 1/76; C02F 1/24; G06Q 50/06

(52) U.S. Cl. CPC E21B 43/40; C02F 1/24; C02F 1/44; C02F 1/72; C02F 1/5236; C02F 9/00; G06Q 50/06; C02F 1/041; C02F 1/04; C02F 1/00; C02F 3/04; C02F 3/12; C02F 1/52; C02F 1/76; C02F 1/32; C02F 2103/06
USPC 210/640; 210/749; 210/703; 210/650; 210/702; 210/758; 210/723; 210/716; 210/767; 203/10; 210/800; 210/616; 210/620; 210/754; 210/748.1

(57) ABSTRACT

A method of supplying engineered water for drilling or hydraulic fracturing of wells, where the water comes from either fresh sources or is recycled from drilling or hydraulic fracturing operations whereby the water is treated for example with a mechanical vapor recompression unit or other treating apparatuses and methods to significantly reduce the concentration of constituents that are deleterious to drilling or hydraulic fracturing chemistries while keeping desirable constituents, such as semi-volatile antimicrobial constituents. The final composition of the engineered water is designed to contain constituents that are optimal for drilling or hydraulic fracturing operations. This method may also include the addition of chemicals or suspended constituents to the treated water that are desirable for drilling or hydraulic fracturing chemistries, or by limiting the treatment of the fresh or recycled water to leave behind constituents that are amenable to reuse operations, as well as refining and recycling components from the waste stream of the recycled waters to provide useful materials for oil field operations. A service for providing minimally engineered waters is also disclosed.

### CROSS-REFERENCE TO RELATED PATENT APPLICATIONS

The present international patent application claims priority to U.S. provisional patent application Ser. No. 61/540,163 filed on 28 Sep. 2011 and to U.S. provisional application Ser. No. 61/563,248 filed on 23 Nov. 2011. Both parent provisional patent applications are incorporated by reference herein in their entireties.

### FIELD OF THE INVENTION

The present invention relates to a method to supply engineered waters for drilling and hydraulic fracturing operations by treatment of fresh or recycled waters to provide engineered waters, which are optimally composed for petroleum field applications. The present invention also relates to a method for optimizing the supply of such engineered water for oil field operations, as well as refining and recycling components from the waste stream of the recycled waters to provide useful materials for oil field operations.

### BACKGROUND OF THE INVENTION

Modern petrochemical exploration and production efforts rely heavily on state of the art mud compositions for efficient drilling and on deep matrix hydraulic fracturing treatment to stimulate production. Production of oil and gas can be optimized by stimulating the wells, such as hydraulic fracturing one or more geological formations in the wellbores. In the case of hydraulic fracturing, pressurized water containing an inert proppant (coarse sand or ceramic oxide) is injected into the earth formation or well matrix to stimulate production with chemical additives to keep the proppant suspended in solution. Additional chemicals are added to control bacterial growth, prevent corrosion and scale, provide lubrication, and to reduce the surface tension of the drilling mud and hydraulic fracturing fluids. All these chemicals (along with the water used in various drilling mud compositions and fracturing fluids) interact with the minerals, deposits and fluids found in the well matrix into which they are pumped. Ideally, all these physical and chemical additives are compatible with all phases of drilling and stimulation to avoid adverse issues with further steps in the process or to ensure maximum production over the useful life of the well. Unfortunately, this is not always the case.

To maintain efficient and persistent production from a stimulated well, the ability of fluid (liquid or gaseous) petrochemicals should remain unimpeded (e.g., retain good conductivity of the petrochemicals through the proppant-filled fractures and conduction zones). During hydraulic fracturing, several events that result in impeded conductivity of hydrocarbons can occur: scaling, poor proppant placement, poor clay control, poor fracturing liquid recovery and sliming, souring or fouling. Each of these events is affected by the chemical composition of the fracturing fluid used as well as possible interactions with the down well mineralogy.

Scaling is the buildup of insoluble alkaline earth and transition metal salts in proppant flows, conduits or return pipes that impedes conductivity. Conditions that promote scaling include high pH and the presence of carbonate, sulfate and sulfide ions. To control scale many different chemicals are used (from which the following list contains a small subset): hydrochloric acid (dissolves scale, other minerals and removes drilling mud damage within the near-wellbore area), phosphoric acid (or solutions of phosphate salts to dissolve scale), acrylamide or acrylamide co-polymers, polycarboxylates (including other chelating agents), and citric, acetic or thioglycolic acids (for iron control).

Poor proppant placement occurs when either the proppant does not get into the fractures efficiently, or when the proppant is unintentionally removed from the fractures and conduits during the process of fracturing fluid collection called flowback. Proppants are usually held in suspension in fracturing fluids through the addition of salts and other chemicals (resulting in what is referred to as slickwater by those skilled in the art) or by addition of chemicals that result in a temporary gel (resulting in what is referred to as gelwater by those skilled in the art). Gelwater fracturing requires a process (thermal, enzymatic or chemical) that reduces the gel-like properties of the fluid ultimately allowing fluid flowback in a process known as breaking. Proppant placement problems often occur due to poor or incomplete gel formation or in poor breaking control (where the gelwater fracturing fluid gel breaks too soon resulting in incomplete proppant placement or too late resulting in unintended proppant removal). Chemicals simultaneously added to water to form and break gelwater include (but are not limited to): guar gum and/or other polysaccharide blends (as gelling agents), petroleum and other hydrotreated light petroleum distillates (as act as carriers), methyl alcohol or glycols (for friction reduction, weatherization or to inhibit breaking), borate, calcium, zirconium and other salts (as crosslinkers or crosslinker enhancers), and calcium or magnesium salts, persulfate, sulfate and other sulfur salts (as breakers or delayed breakers). Since pH also affects both the formation and breaking of gel-based fluids it may be necessary to add or retain ions that do not interfere with or inhibit gelwater chemistries but stabilize pH (or allow for the reliable measurement of pH since very low conductivity water does not contain enough ions to provide dependable electrode responses).

Poor clay control occurs when naturally-occurring clays left over from drilling or from the fractured matrix enter into the proppant flows, conduits or return pipes and thus impede hydrocarbon conductivity therethrough. It will be appreciated by one skilled in the art that these clay particles are prone to swell or aggregate when in the presence of water especially impeding conductivity. Chemicals added to water to prevent clay swelling or reduce clay suspension during flowback include (but are not limited to): methyl, ethyl, isopropyl and 2-butoxyethyl alcohols, lauryl sulfate, naphthalene, halite salts, choline chloride and tetraalkyl ammonium salts.

Sliming, souring or fouling occurs when bacteria are introduced into the fractures or conduits that either (1) grow to such an extent that they form biofilm slimes that occlude conduits, or (2) produce metabolic byproducts that cause corrosion of well components or promote precipitation or scaling in proppant-filled fractures or conduits. It can be appreciated by those skilled in the art that the presence of sulfur-reducing bacteria in high amounts can result in the production of hydrogen sulfide or other sulfur-containing byproducts that promote scaling. Bacteria may also metabolize any remaining carbohydrate-based gelling agents causing them to precipitate and thus blocking conduits. Chemicals added to water to control microbial content include (but are not limited to): glutaraldehyde, formaldehyde, quaternary ammonium salts, tetrakis hydroxymethyl-phosphonium sulfate, chlorates, hypochlorites and a variety of alcohols.

It will be appreciated by one skilled in the art that hydraulic fracturing is a multi-step process where numerous chemicals are used, and where these chemicals mix with those left behind from drilling, previous fracturing operations, arising from dissolved minerals from the well matrix, and from the native water of the geological formations (produced water). Chemical and microbial components may also arise from the water source used to make drilling mud and hydraulic fracturing fluids. In several instances, chemicals left over from one step interfere with the chemistries and purposes of chemicals used in subsequent steps, resulting in inefficient stimulation, the need to use more chemicals to compensate for the presence of another, or necessitating the use of more fresh water for well stimulation.

As drought, resource management and costs require greater recycling of the water used in the petrochemical production processes it becomes imperative that the composition of this water be carefully managed to reduce potential problems.

Hence, it is an object of the present invention to provide engineered waters and/or a service or business in which the treatment of recycled drilling or hydraulic fracturing fluids, e.g., by mechanical vapor recompression or other techniques, is used to provide recycled engineered water that contains few of the ions that may be detrimental for reuse but contains useful ions, semi-volatile organic components and/or near-water boiling point alcohols compatible with the physical and chemical properties of the water needed in the next step of drilling or hydraulic fracturing operations. It is another object of the present invention to similarly treat the waste streams from mechanical vapor recompression or other techniques to recycle or recover useful components for oilfield applications. The present invention is described in its various embodiments in greater detail below.

### SUMMARY OF THE PRESENT INVENTION

One aspect of the present invention is directed to a method of providing an engineered water services where the water comes from either fresh sources or is recycled from drilling or hydraulic fracturing operations. The water is treated, for example with a mechanical vapor recompression unit or other methods described herein, to significantly reduce the concentration of constituents that are deleterious to drilling or hydraulic fracturing chemistries and preferably leaving useful constituents, such as useful ions, semi-volatile organic components and/or near-water boiling point alcohols. Preferably, the final composition of the engineered water is designed to exhibit properties or contain constituents that are optimal for specific or customer-specified drilling or hydraulic fracturing operations.

The useful semi-volatile constituents may exhibit anti-microbial activity, clay control properties, hydraulic fracturing fluid friction reduction properties or a combination thereof. The useful semi-volatile constituents may also depress the freezing point of hydraulic fracturing fluids or drilling muds.

In accordance with another aspect of the present invention, ions are added to the treated water to meet required physical or chemical properties for the needed hydraulic fracturing or drilling step. The ions may come from raw chemical stock, or fresh water, or untreated flow back water or waste streams, or from any combination thereof.

In accordance with another aspect of the present invention, a method of operating an engineered water services business is provided, where the waste streams from mechanical vapor recompression units are treated to recover useful components for reuse in oilfield applications. These useful components can be used as reagents to produce other compounds that are useful in oilfield applications.

### DESCRIPTION OF THE INVENTION

The present invention describes a method of providing engineered waters, where the water comes from either fresh sources, or is recycled from drilling or hydraulic fracturing operations whereby the water is treated for example with a mechanical vapor recompression (MVR) unit or other apparatuses or techniques to significantly reduce the concentration of constituents that are deleterious to drilling or hydraulic fracturing chemistries but leave behind semi-volatile constituents and/or near water boiling points alcohols, discussed above and optionally certain useful minerals, and where the final composition of the engineered water is designed to contain constituents that are optimal for drilling or hydraulic fracturing operations. As stated above, hydraulic fracturing is one stimulating technique to optimize or increase the production of hydrocarbons from wells. This inventive method may also include the addition of chemical or suspended constituents to the treated water that are desirable for drilling or hydraulic fracturing chemistries, or by limiting the treatment of the fresh or recycled water to leave behind constituents that are amenable to reuse operations.

It should be readily understood that the components of the present invention as generally described may be applied in a variety of different configurations depending on customer needs. Thus, the following description of the embodiments of the method is not intended to limit the scope of the invention, as claimed, but is merely representative of selected embodiments of the invention. Reference throughout this specification to “one embodiment” or “an embodiment” means that a particular feature, method, or characteristic described in connection with the embodiment is included in at least one embodiment of the present invention. Thus, appearances of the phrases “in one embodiment” or “in an embodiment” in various places throughout this specification are not necessarily all referring to the same embodiment.

There are a number of ways of treating flowback water for recycling purposes including: addition of organic or inorganic biocides for microbial control, use of ultraviolet radiation to reduce microbial load, removal of soluble organics by means of oxidation (electrocoagulation, galvanocoagulation, ferrate treatment and the like), demineralization (to remove most soluble salts through forward osmosis, membrane distillation, electrodialysis, evaporation, precipitation of insoluble salts, ion exchange resins and the like) and distillation (including mechanical vapor recompression for fast and efficient ion and some soluble volatile and semi volatile organic compound removal). Each of these processes addresses different potential problems, from biocide treatment where chemicals are added to reduce microbial content but all other chemical species remain to mechanical vapor recompression followed by steam stripping to remove all chemical species resulting in pure deionized water.

U.S. Pat. No, 7,842,121 B2 and priority U.S. provisional patent application Nos. 61/540,163 filed on 28 Sep. 2011 and 61/563,248 filed on 23 Nov. 2011, which are incorporated herein by reference, describes a system that includes a mechanical vapor recompression unit, a steam stripper and a secondary heat exchanger that is capable of quickly and efficiently removing all chemical species to below detectable limits from waste water for potential reuse. The purification scheme taught in U.S. Pat. No. 7,842,121 B2 does remove scaling chemicals (alkaline earth and transition metal ions, carbonates, sulfates, sulfides and the like), but it removes all (or significant) amounts of soluble organic species as well. Wherein the removal of all ions and large polymers will eliminate the propensity of the water to form scale, and the removal of boron, calcium and zirconium salts would allow precise control of gelwater breaking, the removal of all semi-volatile organics may not be optimal for water recycling for petrochemical production applications. It will be appreciated by one skilled in the art that Dalton's Law applies to the kind of distillation that occurs during mechanical vapor recompression and that those semi-volatile components with boiling points slightly less than that of water will not be entirely removed; this necessitates the use of a steam stripper as disclosed in U.S. Pat. No. 7,842,121 B2 to remove these compounds. However, many of these semi-volatiles remaining after mechanical vapor recompression are useful components for recycled water for hydraulic fracturing operations. Semi-volatile components commonly found in mechanical vapor recompression-treated recycled water from drilling or hydraulic fracturing operations include, but are not limited to, the following: phenol, o-cresol, m-cresol, p-cresol, benzyl alcohol, formaldehyde and glutaraldehyde. These compounds exhibit some broad spectrum anti-microbial properties and would exhibit fewer propensities to become contaminated with microorganisms during storage and use.

It will also be appreciated by one skilled in the art that near-water boiling point alcohols and other organic components would be retained in mechanical vapor recompression-treated recycled water from drilling or hydraulic fracturing operations. These alcohols would include, but are not limited to, the following: methanol, ethanol, isopropyl alcohol, 1-butanol, 2-butanol, tert-butanol, 1-propanol, 2-pentanol, and 3-pentanol. Several of these compounds are used for clay control, friction reduction (allowing fracturing fluids and proppant to be pumped to the target zone at higher rates and reduced pressures than with water alone), and weatherization of production fluids and would be beneficial in recycled treated waters for hydraulic fracturing fluid reuse.

One skilled in the art would understand that during the treatment process of recycled waters one would generate one or more waste streams and that said waste streams would contain various chemicals added during drilling and hydraulic fracturing operations as well as those solubilized or gleaned from down well minerals. These waste streams can be treated using methods that utilize the physical and chemical properties of the waste components to separate them from other waste components to ultimately recycle or recover chemicals used in oilfield operations. Additionally, these recycled or recovered components can be used as feedstock to generate other useful chemical components or solutions through physical or chemical treatments.

In one embodiment of the invention, the recycled drilling or hydraulic fracturing water is treated by mechanical vapor recompression to eliminate aqueous ions containing boron, calcium or zirconium, thus removing a crosslinker of galactomannan/hydroxypropyl guar gels allowing for more precise control of proppant placement.

In one embodiment of the invention, the recycled drilling or hydraulic fracturing water is treated by mechanical vapor recompression to eliminate aqueous calcium ions or other radical oxidant like peroxidisulfate, sulfate ions, or any combination thereof, thus removing a breaker of galactomannan/hydroxypropyl guar gels allowing for more precise control of proppant placement. In this embodiment enzyme or acid breakers will also be removed.

In another embodiment of the invention, the recycled drilling or hydraulic fracturing water is treated by mechanical vapor recompression to eliminate aqueous ions containing alkaline earth metals ions, transition metal ions, carbonate ions, sulfate ions, sulfide ions, or any combination thereof thus removing components that increase the propensity of the water to form scale.

In one embodiment of the invention, the recycled drilling or hydraulic fracturing water is treated by mechanical vapor recompression thus leaving one or more semi-volatile organic components or near water boiling point alcohols that are useful for their antimicrobial activity, friction reduction properties, clay control abilities, or other useful properties or any combination thereof for reuse in drilling or hydraulic fracturing operations.

In one embodiment of the invention, the recycled drilling or hydraulic fracturing water is treated by mechanical vapor recompression to eliminate iron, thus removing an element that would promote corrosion, scaling, and Fenton chemistries that affect breaking and crosslinking.

In yet another embodiment of the invention, the recycled drilling or hydraulic fracturing water is treated by mechanical vapor recompression to eliminate aqueous ions but leaves useful semi-volatile organic components useful for oilfield fluid applications. In this embodiment, ions are added to the treated water to meet customer requirements for physical/mechanical or chemical properties for the needed hydraulic fracturing or drilling step, with the ions coming from raw chemical stock, or fresh water, or untreated water, or from any combination thereof.

In another embodiment of the invention, the aqueous waste stream from the mechanical vapor recompression (the brine which contains concentrated salts and other particulate matter) or other filtration methods discussed below is treated with physical and chemical methods to separate specific chemical components or classes of components for reuse or as feedstock for the synthesis of other useful chemical compounds or solutions. In this embodiment the physical or mechanical methods used to remove particulate matter(s) include, but are not limited to, filtration, centrifugation, sedimentation, dissolved air floatation, coagulation, and the use of ion-selective or semi-permeable membranes. Chemical methods used to selectively remove specific components or groups of chemically similar components include, but are not limited to, oxidation, flocculation, precipitation, and chelation. It will be apparent to one skilled in the art that it may be useful to employ both physical and chemical methods to purify the waste stream, and that careful application of these various methods in proper order can be effectively utilized to obtain the desired level of purification. For instance, physical separation of inert mineral particles can be accompanied by chemical treatments to oxidize reactive metals to insoluble metal oxides for removal to yield clarified brine solutions. These clarified brines can be further treated by addition of alkaline components to selectively precipitate alkaline earth metals or alternatively be treated with sulfates, carbonates, sulfides and the like to yield brines without scaling ions. The purified brine solutions can be used directly in oilfield applications or as feedstock to produce other useful compounds.

In one specific embodiment of the invention, the non-volatile brine from mechanical vapor recompression can be treated to yield alkaline halite salt brine solutions useful for the electrochemical production of chlorine bleach (sodium hypochlorite). One way this can be accomplished is to (1) employ filtration on the waste stream to remove particulate matter (comprised of insoluble carbonates, silicates and the like), (2) add sodium hydroxide to the filtered waste brine to create insoluble transition metal hydroxides and oxides that can be ultimately removed by filtration, (3) add sodium carbonate or sodium bicarbonate to precipitate many alkaline earth carbonates that can be removed by filtration, (4) removing all precipitated carbonates, hydroxides and oxides by filtration yielding a basic halite salt solution, and (5) flowing an electric current through this solution in an electrolytic cell where chlorine gas is created at the anode which subsequently reacts with hydroxide ions in solution to form hypochlorite ions. In this embodiment calcium and iron ions that promote catalytic destruction of hypochlorite are removed so the bleach solutions can be prepared in higher concentration and can be stored for longer periods. This kind of hypochlorite (bleach) solution has uses in oilfields as an antimicrobial agent.

In another specific embodiment of the invention, the non-volatile brine from mechanical vapor recompression can be treated to yield alkaline halite salt brine solutions useful for the electrochemical production of sodium chlorate. One way this can be accomplished is to (1) employ filtration on the waste stream to remove particulate matter (including insoluble carbonates, silicates and the like), (2) add sodium hydroxide to the filtered waste brine to create insoluble transition metal hydroxides and oxides that can be ultimately removed by filtration, (3) add sodium carbonate or sodium bicarbonate to precipitate many alkaline earth carbonates that can be removed by filtration, (4) removing all precipitated carbonates, hydroxides and oxides by filtration yielding a basic halite salt solution, and (5) flowing an electric current through this solution in an electrolytic cell at elevated temperatures (greater than about 185° F. to minimize hypochlorite concentrations) where chlorine gas is created at the anode which subsequently reacts with hydroxide ions in solution to form chlorate ions. In this embodiment the sodium chlorate can be either used directly in a petroleum field as a bleaching agent, for water purification, as an antimicrobial or as a defoliant. The chlorate can also be used to produce chlorine dioxide (the acid anhydride of chloric acid) through reduction which has numerous oilfield applications.

In another specific embodiment of the invention, the non-volatile brine from mechanical vapor recompression can be treated to yield alkaline halite salt brine that can be used to produce deicing salt (road salt). One way this can be accomplished is to (1) employ filtration on the waste stream to remove particulate matter (including insoluble carbonates, silicates and the like), (2) add sufficient sodium hydroxide to exceed about pH 11 (to improve precipitation of magnesium hydroxide), sodium carbonate and slaked lime (calcium hydroxide) to the filtered waste brine to create insoluble transition metal hydroxides and oxides and alkaline earth carbonates and hydroxides, (3) removing all precipitated carbonates, hydroxides and oxides by filtration yielding a basic halite salt solution, (4) adding hydrochloric acid to the filtrate to produce a neutral solution, and (5) drying the resulting purified salt solution to produce salt crystals of the desirable size for deicing salt as according to industry or government standards, such as AASHTO T 27. It would be appreciated by one skilled in the art that the level of purification would depend on achieving the required level of salt purity (>92%) as required by ASTM D1411 but simultaneously removing other cationic impurities such as iron, calcium, magnesium and barium ions, etc., as described in the previous steps, e.g., steps 2 and 3 so as not to exceed allowable impurity limits. In this embodiment the deicing salt can be used as a weatherizing agent in oilfield applications or as a reagent to make purified brine solutions for drilling applications.

While MVR (mechanical vapor recompression) is a preferred purification technique for the treatment of recycled waters, the present invention is not limited to MVR. Other suitable filtration techniques include, but are not limited to, filtration (based on particle size or based on the electrical charges/attraction of the particles to be removed), evaporation, sedimentation, biological processes (slow sand filters, activated sludge, etc.) chemical processes (flocculation and chlorination), and electromagnetic radiation (ultraviolet light).

Preferably, the concentration of constituents in the water that are deleterious to the specific chemistries for future reuse are reduced, and that the concentration of constituents that are desirable for a specific chemistry, well site, or time can be maintained through addition or by the inclusion or limitation of various treatment steps so that the desirable constituents remain in the recycled water. The service of providing water (or recycled water) that is optimal for drilling, hydraulic fracturing or other petroleum field operations will provide customers engineered water that will yield reliable results with their processes or chemistries, or will reduce the need of certain chemicals to overcome the presence of other deleterious constituents. Preferably, it is advantageous to measure the appropriate constituents and other physical properties (such as pH, conductivity, specific gravity and the like) to ensure that the water provided as the product to the customer meets the desired specifications.

In accordance with another aspect of the present invention, the present inventors recognize that the requirements of the engineered waters may depend on the particular chemistries of the well and may depend on the particular chemistries of the hydrocarbon producing formation where the hydraulic fracture is designed to stimulate. For example, a single well may penetrate sandstone, carbonate, shale, and salt-dome formations. Each producing formation presents a different design challenge. For example, engineered waters for carbonate formations (e.g., ancient ocean reefs) may need to be more acidic than sandstone formations (e.g., ancient riverbeds or ocean floors), but may require less proppants. On the other hand, previously used fractured liquids are not all the same but were designed for specific hydraulic fractured jobs. Previously used fractured liquids, as described in the '121 patent, are filtered to produce clean water at considerable costs and can present disposal challenges to the well operators.

The present inventors recognize that for certain applications it is unnecessary to completely filter or clean the previously used fractured liquids, as discussed above, because some of the components or constituents of the previously used fractured water are useful and can be reused in future hydraulic fractured projects. These useful components or constituents should remain in the previously used water to save the costs of removing them and later adding the same or similar components back in. To optimize, it is useful to match the wells/formations to be stimulated by hydraulic fracturing to the available previously used fractured waters, so that the amount of work to prepare the engineered water is minimized. Additionally, the present inventors recognize that recovery of useful components or constituents from recycled waters for reuse in engineered waters or use as feedstock to produce other desirable components is desirable to save costs and reduce waste hazards and expense. Such services are within the scope of the present invention.

It is preferred that the previously used fractured waters are categorized under a number of identifying factors, including but are not limited to, formation types, acidity, type and concentration of proppants, types and concentrations of ions, semi-volatile constituents, alcohols, physical locations of the used waters, etc. These properties can be measured by readily available sensors and equipment. The previously used fractured waters are treated as commodities, preferably prior to any filtration or purification or processing, and are matched to planned hydraulic fracturing projects within a certain geographical area or distance from the location of the used waters, so that the previously used fractured water is minimally engineered before being reused. Advantageously, the present invention reduces the costs associated with reusing fractured waters.

It is further preferred that the inventory of previously used fractured waters is made public or widely known to well operators to increase their re-use. In one embodiment, the previously used fractured waters are tested and their properties, such as those discussed above, are listed on a website or on an exchange, where well operators or service companies can browse and shop. Alternatively, the well operators may input their requirements for the engineered waters and the website or exchange can identify closest matching, previously used fractured waters, which can be engineered and transported to the well sites.

The website owner may charge a fee for disposing of the previously used fractured waters from well operators and may charge another fee for engineering the same waters to be reused by other well operators. Alternatively, the website owner may charge a listing fee or membership fee for listing the availability of the previously used fractured waters.

An exemplary method for providing a service for engineering previously used fractured waters may include one or more of the following steps:
i. Ascertaining properties such as formation types, acidity, type and concentration of proppants, type and concentration of ions, semi-volatile constituents, alcohols, physical locations of the waters, etc. for the previously used fractured waters,
ii. Publishing the information from step (i) to a public forum, such as a website or an exchange,
iii. Matching the previously used fractured waters to hydraulic fracturing projects, and
iv. Minimally engineering the previously used fractured waters for said hydraulic fracturing projects, wherein one or more constituents of the previously used fractured waters remain.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for engineering a hydraulic fracturing flowback water comprising the steps of:
i. ascertaining properties of the hydraulic fracturing flowback water,
ii. publishing the information from step (i) to a public forum,
iii. matching the hydraulic fracturing flowback water to a hydraulic fracturing project, and
iv. engineering the hydraulic fracturing flowback water for said hydraulic fracturing project, wherein one or more constituents of the previously used fractured water remain.

2. The method of claim 1, wherein the properties of the hydraulic fracturing flowback water comprises at least one of the following: formation types, acidity, type and concentration of proppants, type and concentration of ions, semi-volatile constituents, alcohols, physical locations of the water.

3. The method of claim 1, wherein the public forum is a website or an exchange.

4. The method of claim 1, wherein the (iv) engineering step includes a filtrating step.

5. The method of claim 4, wherein the filtrating step including a mechanical vapor recompressing (MVR) step.

6. The method of claim 1, wherein the (iv) engineering step includes at least one of filtration based on particle size or based on the electrical charges/attraction of the particles to be removed, evaporation, sedimentation, biological processes, chemical process, and electromagnetic radiation.

7. The method of claim 6, wherein the biological processes includes at least one of sand filters or activated sludge.

8. The method of claim 6, wherein the chemical process includes at least one of flocculation or chlorination.

9. The method of claim 6, wherein the electromagnetic radiation includes ultraviolet radiation.

10. A method for separating at least one component of a hydraulic fracturing flowback water comprising the steps of:
i. selectively engineering the hydraulic fracturing flowback water for a hydraulic fracturing project to remove at least one constituent of the hydraulic fracturing flowback water, wherein the engineered water comprises a remaining aqueous stream that contains one or more constituents of the hydraulic fracturing flowback water;
ii. mechanically or physically treating the remaining aqueous stream to modify at least one component of said stream;
iii. chemically treating the remaining aqueous stream to modify at least one component of said stream; and
iv. separating the at least one modified component from steps (ii) or (iii) from the remaining aqueous stream.

11. The method of claim 10, wherein the (ii) mechanically or physically treating step comprises at least one of filtration, centrifugation, sedimentation, dissolved air floatation, coagulation, and the use of ion-selective or semi-permeable membranes.

12. The method of claim 10, wherein the (iii) chemically treating step comprises at least one of oxidation, flocculation, precipitation, or chelation.

13. (canceled)

14. The method of claim 10, wherein
step (i) comprises the step of treating the hydraulic fracturing flowback water by mechanical vapor recompression;
step (ii) comprises the step of filtering the remaining aqueous stream to remove particulate matter,
step (iii) comprises the steps of adding sodium hydroxide to the stream to precipitate insoluble transition metal hydroxides and oxides, adding sodium carbonate or sodium bicarbonate to the stream to precipitate alkaline earth carbonates,
step (iv) comprises the step of filtering the stream to remove the precipitated matters, and further comprises
step (v) conducting an electrical current through the stream to create a chlorine gas.

15. The method of claim 14, wherein the (iv) filtering step yields a basic halite salt solution.

16. The method of claim 14, wherein the (v) conducting step includes flowing electricity in an electrolytic cell, where a chlorine gas at an anode reacts with hydroxide ions to form hypochlorite ions.

17. The method of claim 14 further comprising the steps of (vi) removing calcium ions or iron ions.

18. The method of claim 14, wherein the (v) conducting step includes flowing electricity in an electrolytic cell, where the chlorine gas at an anode reacts at a temperature greater than about 185° F. with hydroxide ions to form chlorate ions.

19. (canceled)

20. The method of claim 18, wherein the chlorate ions undergo further treatment to form chloride dioxide.

21. The method of claim 10 wherein step (i) comprises the step of treating the hydraulic fracturing flowback water by mechanical vapor recompression;
step (ii) comprises the step of filtering the remaining aqueous stream to remove particulate matter;
step (iii) comprises the steps of adding sodium hydroxide to the stream to bring the pH level to above about 11 to precipitate insoluble transition metal hydroxides and oxides, adding sodium carbonate or sodium bicarbonate to the stream to precipitate alkaline earth carbonates, and adding calcium hydroxide to the stream to precipitate hydroxides;
step (iv) comprises the step of filtering the stream to remove the precipitated matters, and further comprises the steps of
(v) adding a hydrochloric acid to the stream to bring the pH level to about neutral; and
(vi) drying the stream to produce crystallized salts.

22. (canceled)

23. The method of claim 21, wherein the crystallized salts are further treated to remove cationic impurities and the crystallized salts have a salt purity of greater than about 92%.

24. (canceled)
